(19) United States
(12) Patent Application Publication
(10) Pub. No.: US 2017/0073565 A1
(43) Pub. Date: Mar. 16, 2017

(54) ORGANIC WATER SCAVENGING ADDITIVES FOR USE IN DRILLING FLUIDS

(71) Applicant: Halliburton Energy Services, Inc., Houston, TX (US)

(72) Inventors: Cato Russell McDaniel, The Woodlands, TX (US); William Walter Shumway, Spring, TX (US)

(73) Assignee: Halliburton Energy Services, Inc., Houston, TX (US)

(21) Appl. No.: 15/122,569

(22) PCT Filed: Apr. 1, 2014
(86) PCT No.: PCT/US2014/032538

§ 371 Date: Aug. 30, 2016

(51) Int. Cl. C09K 8/32; E21B 21/08; E21B 47/00; E21B 7/00

(52) U.S. Cl. CPC C09K 8/32; E21B 7/00; E21B 21/08; E21B 47/00

(57) ABSTRACT

Methods and compositions for scavenging water in drilling operations involving oil-based or invert emulsion-based drilling muds are provided. In one embodiment, the methods comprise: providing an oil-based or invert emulsion drilling fluid comprising an organic water scavenging additive; using the drilling fluid to drill at least a portion of a well bore penetrating at least a portion of a subterranean formation; and allowing at least a portion of the organic water scavenging additive to interact with water in at least a portion of the well bore to consume at least a portion of the water.

### BACKGROUND

The present disclosure relates to compositions and methods for drilling in subterranean formations.

A drilling fluid, or “mud” which a drilling fluid is also often called, is a specially designed fluid that is circulated in a well bore as the well bore is being drilled to facilitate the drilling operation. The various functions of a drilling fluid include removing drill cuttings from the well bore, cooling and lubricating the drill bit, aiding in support of the drill pipe and drill bit, and providing a hydrostatic head to maintain the integrity of the well bore walls and prevent well blowouts.

Specific drilling fluid systems are often selected to optimize a drilling operation in accordance with the characteristics of a particular geological formation. A drilling fluid typically comprises water and/or oil, synthetic oil, or other synthetic material or fluid as a base fluid, with solids in suspension. A non-aqueous based drilling fluid typically contains oil or a synthetic fluid as a continuous phase, and may also contain water, aqueous fluids, or a hygroscopic organic phase dispersed in the continuous phase by emulsification so that there is no distinct layer of water in the fluid. An oil including such dispersed aqueous fluids is generally referred to as an invert emulsion. A number of additives may be included in such oil based drilling fluids and invert emulsions to improve certain properties of the fluid. Such additives may include, for example, emulsifiers, weighting agents, fluid-loss additives or fluid-loss control agents, viscosifiers or viscosity control agents, and alkali.

As a well bore is drilled into a formation, a quantity of fluids (e.g., formation water) and/or gases residing in the formation may flow into the well bore if the pressure in the well bore is less than that of the formation fluids. This phenomenon is often referred to as a “kick”. Such a kick may be caused where the weight of the drilling mud is suddenly lightened or not formulated properly or if the formation being drilled has a higher hydrostatic pressure than anticipated. The influx of water into the well bore, particularly one in which an oil-based drilling mud is used, may cause a number of problems in the drilling operation, including but not limited to dilution of the drilling mud, which causes it to become lighter and exert even less hydrostatic pressure at the bottom of the well. In extreme cases, a kick may even lead to a blowout at the well.

One conventional technique for addressing water kicks with oil-based drilling fluid systems typically involves adding one or more salts (e.g., calcium oxide) to the drilling fluid to prevent an increase the water phase content of the drilling fluid. The drilling fluid is then diluted with additional oil-based mud products to bring the oil-to-water ratio back to the desired levels. However, the salts used in this technique can be hazardous to handle and transport, and their reaction with the water can produce large amounts of heat and/or raise the pH of the fluid, which may cause environmental issues and/or other problems in the drilling operation. Other techniques have involved the use of microwave treatment or distillation to drive off water, neither of which are feasible in many drilling operations.

### BRIEF DESCRIPTION OF THE FIGURES

These drawings illustrate certain aspects of some of the embodiments of the present disclosure, and should not be used to limit or define the disclosure.

FIGS. 1A, 1B, 1C, 1D, 1E, 1F, and 1G are illustrations of chemical reactions that may be used in accordance with certain embodiments of the present disclosure.

FIG. 2 is a diagram illustrating an example of a well bore drilling assembly that may be used in accordance with certain embodiments of the present disclosure.

While embodiments of this disclosure have been depicted and described and are defined by reference to example embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

Illustrative embodiments of the present disclosure are described in detail herein. In the interest of clarity, not all features of an actual implementation may be described in this specification. It will of course be appreciated that in the development of any such actual embodiment, numerous implementation-specific decisions may be made to achieve the specific implementation goals, which may vary from one implementation to another. Moreover, it will be appreciated that such a development effort might be complex and time-consuming, but would nevertheless be a routine undertaking for those of ordinary skill in the art having the benefit of the present disclosure.

The present disclosure relates to compositions and methods for drilling in subterranean formations, and more specifically, compositions and methods for scavenging water in drilling operations involving oil-based or invert emulsion-based drilling muds.

The methods and compositions of the present disclosure generally involve using a water scavenging additive to consume water present in a well bore, for example, due to a quantity of aqueous fluids from the formation (e.g., a water kick) entering the well bore during a drilling operation. The water scavenging additives of the present disclosure generally comprise organic compounds that may be activated and/or catalyzed in either an acid, base, or neutral pH to form species that will react with water (i.e., hydrolyze), thus consuming some portion of that water. The methods and compositions of the present disclosure are generally used in conjunction with drilling operations where an oil-based drilling mud or an invert emulsion drilling mud is used.

The methods and compositions of the present disclosure may, among other benefits, provide a means of addressing water kicks in well bores with fewer environmental, safety, toxicity, and/or other risks as compared to conventional methods. In certain embodiments, the methods and compositions of the present disclosure may address water kicks while maintaining the oil-to-water ratio of an invert emulsion drilling fluid within acceptable limits without diluting the drilling fluid with additional oil-based fluid and/or without the use of salts. In certain embodiments, the methods and compositions of the present disclosure also may be used to prevent contamination and commingling of oil-based drilling fluids with water more generally.

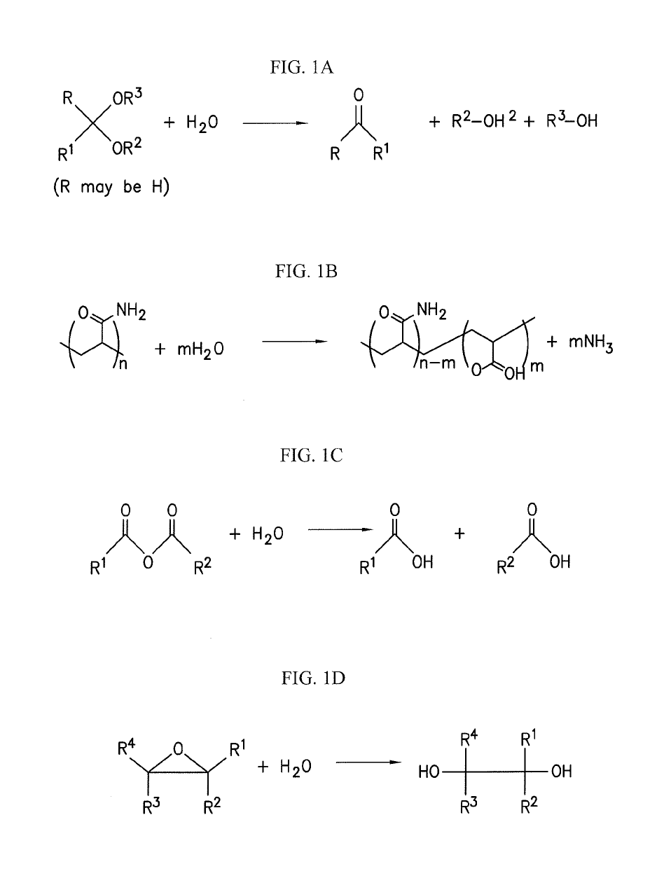

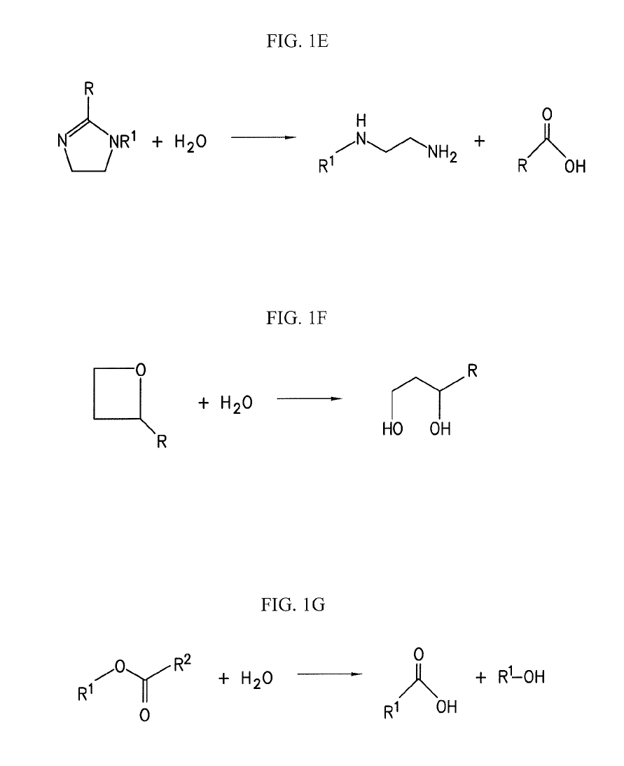

The organic water scavenging additives of the present disclosure may include one or more of the following types of compounds: acetals, ketals, amides, anhydrides, epoxides, imidazolines, oxetanes, certain esters, combinations thereof, and derivatives thereof. Each of the various types of organic water scavenging additives noted above may include polymeric compounds comprising repeating units that include the listed functional groups, as well as cyclic structures or functional groups. Examples of acetals and ketals that may be suitable for use in the methods and compositions of the present disclosure include, but are not limited to, keotane (acetone dimethyl acetal or 2,2-dimethoxypropane), cyclic sugars having ketal functionality (e.g., fructose). Examples of amides that may be suitable for use in the methods and compositions of the present disclosure include, but are not limited to, polyacrylamides. Examples of anhydrides that may be suitable for use in the methods and compositions of the present disclosure include, but are not limited to, poly(maleic anhydride), poly(butadiene-maleic anhydride), poly(styrene/maleic anhydride), poly(maleic anhydride-1-octadecene, and poly(ethylene-maleic anhydride). Examples of esters that may be suitable for use in the methods and compositions of the present disclosure include short-chain, water-miscible esters, such as methyl esters. Without limiting the mechanism of action of the present disclosure to any particular theory, the reaction mechanisms by which various types of water scavenging additives are believed to consume water are shown in FIG. 1A through 1G (FIG. 1A: acetals/ketals; FIG. 1B: amides (e.g., polyacrylamide); FIG. 1C: anhydrides; FIG. 1D: epoxides; FIG. 1E: imidazolines; FIG. 1F: oxetanes; and FIG. 1G: esters). These reactions and/or other reactions may incorporate the water molecules into the reaction products, thus consuming water present in the well bore where they are introduced.

In certain embodiments, the reactions in FIG. 1A through 1G and/or other reactions of the water scavenging additive with water may produce oleaginous reaction products (e.g., fatty acids) that can be incorporated into an oil-based drilling fluid and/or the oil phase of an invert emulsion in the well. Such reaction products may, among other benefits, counteract dilution of the drilling fluid by any water not consumed by the water scavenging additive. In other embodiments, certain reaction products (e.g., alcohols) may have hygroscopic properties, which may enhance the activity of the aqueous phase of an invert emulsion fluid.

The amount of the water scavenging additive added to a drilling fluid of the present disclosure may depend upon a number of factors, including but not limited to the reactivity and/or molecular weight of the additive, the amount of water that it is intended to remove, the volume of the well, and other factors that will be recognized by a person of ordinary skill in the art with the benefit of this disclosure. Generally, the water scavenging additive should be added to the drilling fluid in a stoichiometric amount relative to the amount of water to be removed from the well bore.

The drilling fluids used in the methods and compositions of the present disclosure generally comprise an oil-based drilling mud or an invert emulsion drilling mud. Oil-based fluids that may be used to form an oil-based drilling mud include, but are not limited to, synthetic oils comprising esters or olefins; diesel oils; mineral oils (e.g., n-paraffins, iso-paraffins, cyclic alkanes, branched alkanes) and mixtures thereof. Examples of commercially-available oil-based fluids include, but are not limited to, ESCAID® 110 (desulfurized hydrogenated kerosene oil base from ExxonMobil Chemical Company in Houston, Tex.), XP-07™ (synthetic normal alkane fluid available from Halliburton Energy Services), and PUREDRILL™ drilling fluids (available from Petro-Canada). Invert emulsion drilling muds generally comprise an external oil or oleaginous phase and an internal aqueous or hygroscopic organic phase. The external phase may comprise one or more of the oil-based fluids listed above. The internal phase may comprise any aqueous or hygroscopic organic fluid known in the art, including but not limited to water, brines, alcohols (e.g., glycols such as polyethylene glycol, glycerol), carbohydrates, glycosides, and mixtures thereof. The oil-to-water ratio of such invert emulsions may range from about 40:60 to about 98:2. Examples of commercially-available invert emulsion drilling fluids include, but are not limited to, ACCOLADE®, ENCORE®, INTEGRADE®, INNOVERT®, ENVIROMUL™, and PETROFREE® fluids, each of which is available from Halliburton Energy Services.

In certain embodiments, the aqueous phase of invert emulsions used in the methods and compositions of the present disclosure may be substantially “salt-free”, which means substantially free of any added calcium chloride salts, or known substitutes such as potassium chloride, sodium chloride, magnesium sulfate, potassium acetate or formate. Nevertheless, such a “salt-free” aqueous phase may comprise such salts in insubstantial quantities (e.g., in quantities less than about 3 pounds per barrel), as may be present, for example, in use in the field as when the fluid of the present disclosure is mixed with recycled drilling fluids or picked up from the formation in the course of a drilling operation. In certain embodiments, the invert emulsions used in the methods and compositions of the present disclosure may be substantially “clay free”, which means that they are made without addition of any organophilic clays or lignites to the invert emulsion. In certain embodiments, substantially “salt-free” and/or “clay-free” drilling fluids that may be suitable for use in the method of the present disclosure may comprise an invert emulsion that comprises an oleaginous continuous phase (e.g., paraffin and/or mineral oil), an alcohol (e.g., a glycerol, polyglycerol, or combination thereof) in the internal phase, a quaternary ammonium emulsifier, and finely divided argillaceous solids. In certain embodiments, substantially “salt-free”and/or “clay-free” drilling fluids that may be suitable for use in the method of the present disclosure may comprise an invert emulsion that comprises an oleaginous continuous phase that comprises a hydrocarbon liquid, an internal phase that comprises a hygroscopic liquid, a polymeric suspending agent comprising urea linkages, and a particulate having a density of less than 3.5 g/cm³. In certain embodiments, a test fluid consisting essentially of the continuous phase, the internal phase, the suspending agent, and the particulate referenced above, and in the same proportions as the drilling fluid, and after static aging for 2 months at a temperature of 200° F. (93.3° C.), may exhibit a 10-minute gel strength of at least 30 lb/100 ft2 (1,436 Pa) at a temperature of 120° F. (48.9° C.).

The compositions of the present disclosure optionally may comprise any number of additional additives in combination with the catechol component and amine component. Other examples of such additional additives include, but are not limited to, weighting agents, surfactants, emulsifiers, acids, fluorides, fluid loss control additives, gas, nitrogen, carbon dioxide, surface modifying agents, tackifying agents, foamers, corrosion inhibitors, scale inhibitors, catalysts, clay control agents, biocides, friction reducers, antifoam agents, bridging agents, dispersants, flocculants, additional H₂S scavengers, CO₂ scavengers, oxygen scavengers, lubricants, viscosifiers, breakers, relative permeability modifiers, resins, particulate materials (e. g., proppant particulates), wetting agents, coating enhancement agents, filter cake removal agents, and the like. A person skilled in the art, with the benefit of this disclosure, will recognize the types of additives that may be included in the fluids of the present disclosure for a particular application.

The methods and compositions of the present disclosure may be used during or in conjunction with any subterranean drilling operation where an oil-based drilling mud or an invert emulsion drilling mud is used. For example, the methods and/or compositions of the present disclosure may be used in the course of drilling operations in which a well bore has been drilled to penetrate a subterranean formation. In certain embodiments, this may be accomplished using the pumping system and equipment used to circulate the drilling fluid in the well bore during the drilling operation, which is described below.

The drilling fluids and/or water scavenging additives of the present disclosure may be introduced into the well bore using any method or equipment known in the art. In certain embodiments, a drilling fluid and/or water scavenging additive of the present disclosure may be circulated in the well bore using the same types of pumping systems and equipment at the surface that are used to introduce drilling fluids and/or other treatment fluids or additives into a well bore penetrating at least a portion of the subterranean formation. In certain embodiments, the water scavenging additives of the present disclosure may be added to an oil-based drilling fluid that does not include a significant aqueous component, or to an invert emulsion drilling fluid with an internal phase that does not comprise water (e.g., glycerin or glycol), before the drilling fluid is introduced into the subterranean formation (e.g., at the drilling site or offsite before the drilling fluid is transported to the drilling site). In these embodiments, the water-scavenging additive may be used as a preventative measure to treat and/or remove any water that the drilling fluid may encounter, even before a water kick has been detected.

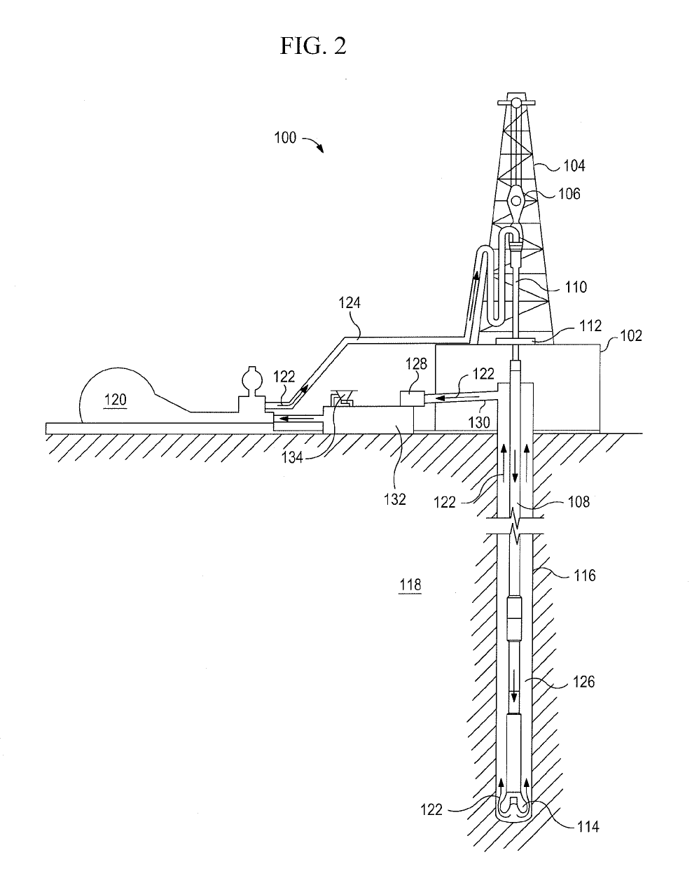

The exemplary methods and compositions disclosed herein may directly or indirectly affect one or more components or pieces of equipment associated with the preparation, delivery, recapture, recycling, reuse, and/or disposal of the disclosed compositions. For example, and with reference to FIG. 2, the disclosed methods and compositions may directly or indirectly affect one or more components or pieces of equipment associated with an exemplary wellbore drilling assembly 100, according to one or more embodiments. It should be noted that while FIG. 2 generally depicts a land-based drilling assembly, those skilled in the art will readily recognize that the principles described herein are equally applicable to subsea drilling operations that employ floating or sea-based platforms and rigs, without departing from the scope of the disclosure.

As illustrated, the drilling assembly 100 may include a drilling platform 102 that supports a derrick 104 having a traveling block 106 for raising and lowering a drill string 108. The drill string 108 may include, but is not limited to, drill pipe and coiled tubing, as generally known to those skilled in the art. A kelly 110 supports the drill string 108 as it is lowered through a rotary table 112. A drill bit 114 is attached to the distal end of the drill string 108 and is driven either by a downhole motor and/or via rotation of the drill string 108 from the well surface. As the bit 114 rotates, it creates a borehole 116 that penetrates various subterranean formations 118.

A pump 120 (e.g., a mud pump) circulates drilling fluid 122 through a feed pipe 124 and to the kelly 110, which conveys the drilling fluid 122 downhole through the interior of the drill string 108 and through one or more orifices in the drill bit 114. The drilling fluid 122 is then circulated back to the surface via an annulus 126 defined between the drill string 108 and the walls of the borehole 116. At the surface, the recirculated or spent drilling fluid 122 exits the annulus 126 and may be conveyed to one or more fluid processing unit(s) 128 via an interconnecting flow line 130. After passing through the fluid processing unit(s) 128, a “cleaned” drilling fluid 122 is deposited into a nearby retention pit 132 (i.e., a mud pit). While illustrated as being arranged at the outlet of the wellbore 116 via the annulus 126, those skilled in the art will readily appreciate that the fluid processing unit(s) 128 may be arranged at any other location in the drilling assembly 100 to facilitate its proper function, without departing from the scope of the scope of the disclosure.

One or more of the disclosed additives may be added to the drilling fluid 122 via a mixing hopper 134 communicably coupled to or otherwise in fluid communication with the retention pit 132. The mixing hopper 134 may include, but is not limited to, mixers and related mixing equipment known to those skilled in the art. In other embodiments, however, the disclosed additives may be added to the drilling fluid 122 at any other location in the drilling assembly 100. In at least one embodiment, for example, there could be more than one retention pit 132, such as multiple retention pits 132 in series. Moreover, the retention pit 132 may be representative of one or more fluid storage facilities and/or units where the disclosed additives may be stored, reconditioned, and/or regulated until added to the drilling fluid 122.

As mentioned above, the disclosed fluids and additives may directly or indirectly affect the components and equipment of the drilling assembly 100. For example, the disclosed fluids and additives may directly or indirectly affect the fluid processing unit(s) 128 which may include, but is not limited to, one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, any fluid reclamation equipment, or the like. The fluid processing unit(s) 128 may further include one or more sensors, gauges, pumps, compressors, and the like used store, monitor, regulate, and/or recondition the fluids.

The disclosed methods and compositions may directly or indirectly affect the pump 120, which representatively includes any conduits, pipelines, trucks, tubulars, and/or pipes used to fluidically convey the fluids and additives downhole, any pumps, compressors, or motors (e.g., topside or downhole) used to drive the fluids and additives into motion, any valves or related joints used to regulate the pressure or flow rate of the fluids and additives, and any sensors (i.e., pressure, temperature, flow rate, etc.), gauges, and/or combinations thereof, and the like. The disclosed fluids and additives may also directly or indirectly affect the mixing hopper 134 and the retention pit 132 and their assorted variations.

The disclosed methods and compositions also may directly or indirectly affect the various downhole equipment and tools that may come into contact with the compositions such as, but not limited to, the drill string 108, any floats, drill collars, mud motors, downhole motors and/or pumps associated with the drill string 108, and any MWD/LWD tools and related telemetry equipment, sensors or distributed sensors associated with the drill string 108. The disclosed methods and compositions may also directly or indirectly affect any downhole heat exchangers, valves and corresponding actuation devices, tool seals, packers and other wellbore isolation devices or components, and the like associated with the wellbore 116. The disclosed methods and compositions may also directly or indirectly affect the drill bit 114, which may include, but is not limited to, roller cone bits, PDC bits, natural diamond bits, any hole openers, reamers, coring bits, etc.

The disclosed methods and compositions also may directly or indirectly affect the various equipment and/or tools (not shown) used at a well site or in drilling assembly 100 to detect quantities of formation fluids (e.g., kicks) entering wellbore 116. Such equipment and/or tools may include, but are not limited to, pressure gauges, flow meters, sensors (e.g., float sensors used to monitor the level of drilling fluid in retention pit 132, downhole sensors, sensors in return flow line 130, etc.), seismic monitoring equipment, logging equipment, and the like. In certain embodiments, the drilling assembly 100 could further include equipment operatively connected to the equipment used to detect a kick that is configured to automatically (i.e., without human intervention at the specified time) introduce one or more water scavenging additives into wellbore 116 when a kick is detected.

While not specifically illustrated herein, the disclosed methods and compositions may also directly or indirectly affect any transport or delivery equipment used to convey the compositions to the drilling assembly 100 such as, for example, any transport vessels, conduits, pipelines, trucks, tubulars, and/or pipes used to fluidically move the compositions from one location to another, any pumps, compressors, or motors used to drive the compositions into motion, any valves or related joints used to regulate the pressure or flow rate of the compositions, and any sensors (i.e., pressure and temperature), gauges, and/or combinations thereof, and the like.

An embodiment of the present disclosure is a method comprising: providing an oil-based or invert emulsion drilling fluid; using the drilling fluid to drill at least a portion of a well bore penetrating at least a portion of a subterranean formation; introducing an organic water scavenging additive into the drilling fluid; and allowing at least a portion of the organic water scavenging additive to interact with water in at least a portion of the well bore to consume at least a portion of the water.

Another embodiment of the present disclosure is a method comprising: providing an oil-based or invert emulsion drilling fluid comprising an organic water scavenging additive; using the drilling fluid to drill at least a portion of a well bore penetrating at least a portion of a subterranean formation; and allowing at least a portion of the organic water scavenging additive to interact with water in at least a portion of the well bore to consume at least a portion of the water.

Another embodiment of the present disclosure is a method comprising: providing an invert emulsion drilling fluid; using the drilling fluid to drill at least a portion of a well bore penetrating at least a portion of a subterranean formation; detecting at least one kick in the well bore during drilling; and introducing an organic water scavenging additive into the drilling fluid after detecting the kick, the organic water scavenging additive being selected from the group consisting of: an acetal; a ketal; an amide; an anhydride; an epoxide; an imidazoline; an oxetane; a water-miscible ester; any combination thereof; and any derivative thereof.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

What is claimed is:

1. A method comprising:
providing an oil-based or invert emulsion drilling fluid;
using the drilling fluid to drill at least a portion of a well bore penetrating at least a portion of a subterranean formation;
introducing an organic water scavenging additive into the drilling fluid; and
allowing at least a portion of the organic water scavenging additive to interact with water in at least a portion of the well bore to consume at least a portion of the water.

2. The method of claim 1 wherein the organic water scavenging additive is introduced into the drilling fluid after a quantity of aqueous fluid from the subterranean formation enters the well bore.

3. The method of claim 2 further comprising detecting the quantity of aqueous fluid entering the well bore using one or more sensors configured to monitor flow of the drilling fluid.

4. The method of claim 1 wherein the organic water scavenging additive comprises at least one compound selected from the group consisting of: an acetal; a ketal; an amide; an anhydride; an epoxide; an imidazoline; an oxetane; a water-miscible ester; any combination thereof; and any derivative thereof.

5. The method of claim 1 wherein the organic water scavenging additive comprises an acetal.

6. The method of claim 1 wherein the organic water scavenging additive reacts with the water to produce one or more oleaginous reaction products.

7. The method of claim 1 wherein the organic water scavenging additive reacts with the water to produce one or more hygroscopic reaction products.

8. The method of claim 1 wherein the base fluid of the drilling fluid consists essentially of an oil-based fluid.

9. The method of claim 1 wherein the drilling fluid comprises an invert emulsion.

10. The method of claim 1 wherein the drilling fluid comprises an invert emulsion having a substantially salt-free internal phase.

11. The method of claim 1 wherein the drilling fluid comprises an invert emulsion having a glycol-based internal phase.

12. The method of claim 1 further comprising introducing the drilling fluid into the well bore using one or more pumps and a drillstring.

13. A method comprising:
providing an oil-based or invert emulsion drilling fluid comprising an organic water scavenging additive;
using the drilling fluid to drill at least a portion of a well bore penetrating at least a portion of a subterranean formation; and
allowing at least a portion of the organic water scavenging additive to interact with water in at least a portion of the well bore to consume at least a portion of the water.

14. The method of claim 13 wherein the drilling fluid comprises an invert emulsion having an internal phase that does not comprise water.

15. The method of claim 13 wherein drilling fluid comprises an invert emulsion having a substantially salt-free glycol internal phase.

16. The method of claim 13 wherein the organic water scavenging additive comprises at least one compound selected from the group consisting of: an acetal; a ketal; an amide; an anhydride; an epoxide; an imidazoline; an oxetane; a water-miscible ester; any combination thereof; and any derivative thereof.

17. A method comprising:
providing an invert emulsion drilling fluid;
using the drilling fluid to drill at least a portion of a well bore penetrating at least a portion of a subterranean formation;
detecting at least one kick in the well bore during drilling; and
introducing an organic water scavenging additive into the drilling fluid after detecting the kick, the organic water scavenging additive being selected from the group consisting of: an acetal; a ketal; an amide; an anhydride; an epoxide; an imidazoline; an oxetane; a water-miscible ester; any combination thereof; and any derivative thereof.

18. The method of claim 17 wherein the kick is detected by detecting a quantity of aqueous fluid entering the well bore using one or more sensors configured to monitor flow of the drilling fluid.

19. The method of claim 17 wherein the organic water scavenging additive comprises an acetal.

20. The method of claim 17 wherein the invert emulsion has a substantially salt-free glycol internal phase.
